(19) United States
(12) Patent Application Publication
(10) Pub. No.: US 2026/0233867 A1
(43) Pub. Date: Aug. 13, 2026

(54) INTELLIGENT FLIGHT MANAGEMENT SYSTEM FOR MULTIPLE UAVS IN BASE STATION NETWORKS

(71) Applicant: MENATIR INC., Wilmington, DE (US)

(72) Inventors: Oleksandr DANYLENKO, Holubivka (UA); Oleg KROT, Pacific Palisades, CA (US); Yurii LAZEBNIKOV, Pacific Palisades, CA (US)

(21) Appl. No.: 19/469,503

(22) PCT Filed: Sep. 13, 2023
(86) PCT No.: PCT/US2023/032609

§ 371 Date: Sep. 26, 2025

Related U.S. Application Data
(60) Provisional application No. 63/454,998, filed on Mar. 28, 2023.

(51) Int. Cl. B64U 80/40; B64U 10/25; B64U 50/37; B64U 70/90; B64U 80/70; G08G 5/57

(52) U.S. Cl. CPC B64U 80/40; B64U 10/25; B64U 50/37; B64U 70/90; B64U 80/70; G08G 5/57

(57) ABSTRACT

The present invention relates to a system and method for operating an intelligent unmanned aerial vehicle (UAV) management system capable of 24/7 worldwide operation. Base stations receive user-generated tasks, which include flight zones, payloads, flight times, and optionally post-processing of received data. The system operates autonomously. It is configured to send flight missions formulated and transmitted to the base station to initiate a series of steps such as aircraft checks, exit route selection based on wind conditions, and pre-flight procedures. Base stations direct UAVs to execute user tasks, transmitting video and other useful information to the base station and user. Upon completion, the aircraft returns to the base station, where it lands, and its battery is recharged, and its data is shared with the user. The UAV management system enables efficient, continuous operation of multiple UAVs assigned to various base stations globally, catering to a wide range of mission requirements.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### FIELD OF THE INVENTION

The present invention is related to unmanned aerial systems. In particular, the present technology relates to unmanned aerial vehicle (UAV) systems, including autonomous UAV systems, and operational systems, devices, and methods used to control UAVs as platforms. The platform provides access to a remote management system deployed in the cloud, wherein the users and operators can access a fleet of UAVs using a web interface or a mobile device from anywhere on the globe. Users can launch and independently control the fleet of UAVs through a remote access point.

### BACKGROUND

UAVs are increasingly being used in various industries, such as military, agriculture, and logistics. However, the storage, deployment and management of UAVs can be a complex and time-consuming task.

Generally, UAVs are part of systems that also include ground-based controllers in communication with a corresponding UAV. In these systems, the controllers are often operated by a human such that the UAV is flown under full or partial control by the human. Additionally, or alternatively, the ground-based controller may be fully or partially operated without a human, or a UAV might include a controller (e.g., an autopilot) onboard, thereby enabling the UAV to fly with various degrees of autonomy.

For advanced operations such as surveillance at higher altitudes and speeds, and in complicated or forbidding environments, only a few UAV systems are currently available that provide for image and video capture and remote control from a device on the ground being flown by a trained pilot. However, these systems require piloting using direct control of the UAV similar to other fixed wing or rotor craft. While effective to a degree, such control systems require significant expertise on the part of the remote pilot. Without proper training, small errors on the part of the pilot can cause crashes. Such systems can be complicated and prohibitively expensive to own and maintain. Instead, scalable systems are needed that provide for indirect control of an otherwise autonomous UAV using new intuitive and user-friendly paradigms that can operate under normal conditions or advanced operations.

### BRIEF SUMMARY OF THE INVENTION

The present invention relates to a system and method for storing, deploying and managing a plurality of unmanned aerial vehicles. The system includes the following components:
1. A plurality of UAV base stations having a housing container for storing and charging of a plurality of UAVs.
2. A plurality of UAVs for holding an assortment of payloads.
3. A system control center comprising a UAV management system.
4. A computer station comprising a user application for placing mission requests.

The UAV base stations have a housing container for storing and charging the UAVs. The housing container comprises a roof for opening and closing the top of the housing container, a plurality of cassette covers comprising UAV landing and takeoff platform positioned under the roof, a manipulator for receiving, sorting, and arranging the UAVs inside the cassette covers positioned within the housing container. The manipulator further comprises a camera or a sensor for determining the exact location of a UAV after it lands. The container may further comprise an air conditioning unit and a heater to maintain a predetermined temperature environment inside the base station.

The base station further comprises an electronics rack unit, power supply unit for the container, a manipulator micro control unit (MCU) for controlling the manipulator, a tower MCU for controlling the plurality of lifts or elevators, and a charge control unit for managing the charging, downloading the data and/or recharging of the UAVs.

The cassette covers are configured for raising the UAVs up to the takeoff and landing platform or lowering the UAVs down below the takeoff and landing platform for charging, recharging, data transfer, or storing of the UAVs. The cassette covers further comprise a plurality of lifts or elevators that facilitate the raising or lowering of the UAVs.

The cassette covers have a dual function, as a landing platform and as a housing unit for storing UAVs and shielding them from the external environment.

The tower MCU controls the charging or recharging of the UAVs, lowering, and raising of cassette covers, and opening and closing of the roof. The housing container is movable. The UAV base station is part of an interconnected network comprising all the other UAV storage and charging facilities having base stations along with all the networked UAVs.

The UAV base station controls payloads of the networked UAVs and is variably connected to the server via a USB. The control platform is connected to the server through Ethernet. The base station is internally provided with a data storage and management module, which is configured for storing of UAV in-flight and maintenance information as well as newly acquired stream of data.

The UAVs are interconnected to each other, the UAV base stations, and are configured to communicate with the base station to send video streams and photos. The UAV storage and charging facilities are configured to communicate with the system control center to receive UAV mission logs and send acquired data, which may comprise camera streams or results files. The system control center is configured to communicate with the computer station to send a data stream and receive mission requests.

Each of the UAVs comprises a fuselage body having a front section, a middle section, and a back-end section. The back-end section has two horizontal stabilizers and a vertical stabilizer. A pair of wings affixed to the sides of the middle section of the fuselage extended outward, the wings having a top side and a bottom side.

The UAVs further include a plurality of propulsion systems for providing lift and propulsion, and a payload compartment for holding various payloads such as cameras, sensors, and communication equipment.

The system and method of the present invention provides a way for storing, deploying and managing a plurality of UAVs in an efficient, safe and organized manner. The interconnected UAV base stations and UAVs allow for easy communication, charging and deployment of the UAVs. The system control center and computer station provides a user-friendly interface for managing and controlling the UAVs and their payloads.

In addition, the data storage and management module within the base station allows for storage and organization of UAV in-flight and maintenance information as well as newly acquired data streams, providing valuable insights and analytics for further improving the UAVs performance and mission capabilities. The movable housing container allows for easy deployment and relocation of the UAV storage and charging facilities as needed.

Furthermore, the use of cassette covers for holding and moving the UAVs, and the use of lifts or elevators for raising or lowering the UAVs, ensures that the UAVs are stored and charged in a safe and secure manner. The use of the manipulator with a camera or sensor to determine the exact location of the UAV once it lands and the use of the tower MCU to control the charging, recharging, lowering, raising and opening and closing of the roof, provides added convenience and efficiency in the deployment and management of the UAVs.

The UAV storage and deployment system and base station of the present invention provides a comprehensive solution for storing, deploying and managing a plurality of UAVs in an efficient, safe, and organized manner. It will be beneficial for various industries, such as agriculture, logistics, and various well known commercial applications that rely on UAVs for their operations.

Moreover, the present invention provides for an UAV movement system using a network of base stations. The area of work of each base station is part of the airspace around it, and a useful mission created within this area will be performed by the appropriate base station.

The area of overlap of multiple base stations is part of the airspace that is simultaneously controlled by two or more base stations. In a situation where the useful mission is fully located in the overlap zone, the base station is selected for its implementation based on the following conditions:
Availability of UAVs with the required quantity
Readiness to complete the flight task.
The distance from the base station to the farthest flight point is minimal

If a useful mission cannot be found in the radio frequency range of any base station, or if it is located in the overlap zone of two or more base stations, the user will be asked to share the flight task within several base stations.

The area of responsibility of each base station is part of the airspace around it in which the flight task of the UAV is set automatically. Spare landing ground and a waiting area are also located within the area of responsibility.

The spare landing ground is a pre-prepared UAV type Tailsitter with clearly defined coordinates and is used for emergency landing of a UAV in case of failure of the base station, failure of onboard equipment, adverse weather conditions, or other emergency situations.

The waiting area is part of the airspace in the base station that is used to organize the traffic when landing several UAVs at once.

In one base station, a plurality of UAVs can be present at the same time, each of which performs a flight task in a separate UAV. If the zones of multiple UAVs intersect, the system distinguishes them using one of the following method attributes:
Distribution by height of flight
Distribution by time (shown graphically)
Distribution by priority of missions

Each base station has an assigned coverage zone, wherein optimally no more than three UAVs can operate at the same time per the base station coverage zone.

The elevation process refers to the trajectory transition of the UAV from vertical flight path to a horizontal flight path (direct transition), the increase of useful mission height, and exit from the zone of responsibility assigned by a base station.

The landing process refers to the entrance of the UAV to the base station, reduction of UAV to the height of the reverse transition, the transition of UAV to the copy mode (reverse transition), and landing on base station or spare landing ground.

The flight task of a UAV can be either a service or a custom task. A custom flight task consists of three parts:
Service and exit a zone of responsibility
Receive and complete useful missions
Entry to the base station and landing

The formation of a custom flight task takes place in a semi-automatic mode. A useful mission (second part) is created by the user, while the first and third parts are automatically selected from the list of pre-created routes. Such routes are built at the stage of installation of base stations in the place of permanent location and take into account the features of the landscape, the organization of airspace, other obstacles, and weather conditions.

The service flight tasks include a test flight within the base station, migration of a UAV from one base station to another, and orthophoto terrain within the area of responsibility.

The instantly disclosed UAV storage, deployment and movement system using an interconnected base stations network also provides a number of advantages such as:
Interconnected network of UAVs and UAV base stations for easy communication and coordination.
User-friendly interface for managing and controlling the UAVs and their payloads.
Data storage and management module for storing and organizing UAV in-flight and maintenance information as well as newly acquired data streams.
Movable housing container for easy deployment and relocation of the UAV storage and charging facilities.
Safe and secure storage and charging of UAVs through the use of cassette covers and lifts or elevators.
Convenient and efficient deployment and management of UAVs through the use of manipulator and tower MCU.

Moreover, the invention can be further improved by incorporating new technologies such as advanced sensors, cameras, and communication systems which will enhance the performance and capabilities of the UAVs and the overall system.

### BRIEF DESCRIPTION OF THE DRAWINGS

For the purpose of facilitating an understanding of the subject matter sought to be protected, the accompanying drawings, its construction and operation, when considered along with the accompanying description, the subject matter sought to be protected, and many of its advantages should be readily understood and appreciated.

FIG. 1 is a system diagram illustrating an UAV storage and deployment system, according to some embodiments of the present disclosure.

FIG. 1A depicts coverage zones assigned by a base station, according to some embodiments of the present disclosure.

FIG. 1B depicts a network diagram having multiple users command and control multiple base stations, according to some embodiments of the present disclosure.

FIG. 2 shows a block diagram of the operational system for managing an UAV base station 200 in detail, according to some embodiments of the present disclosure.

FIG. 3 depicts a 3D view of a container for holding UAVs, according to some embodiments of the present disclosure.

FIG. 3A depicts all the main parts of the container from FIG. 3, according to some embodiments of the present disclosure.

FIG. 3B depicts a short side view and dimensions of a container housing one or more UAVs, according to some embodiments of the present disclosure.

FIG. 3C depicts a long side view and dimensions of a container for holding UAVs, according to some embodiments of the present disclosure.

FIG. 3D depicts a container in a 3D view, having its roof open while holding a UAV, according to some embodiments of the present disclosure.

FIG. 4 is a depiction of a UAV handling assembly of the manipulator, according to some embodiments of the present disclosure.

FIG. 5 is a depiction of the lift or elevator for raising and lowering of the UAVs in the container, according to some embodiments of the present disclosure.

FIG. 6 is a depiction of the container add-on providing additional support to the roof, according to some embodiments of the present disclosure.

FIG. 7 is a depiction of the container roof and its parts, according to some embodiments of the present disclosure.

FIG. 8 is a depiction of the landing and takeoff platform, according to some embodiments of the present disclosure.

FIG. 9 is a block diagram illustrating the UAV and its management system, according to some embodiments of the present disclosure.

FIG. 10 is a depiction of the UAV over a charging platform, according to some embodiments of the present disclosure.

FIG. 11 is a depiction of the UAV from the top view, according to some embodiments of the present disclosure.

FIG. 12 is a zoomed-in view of the charging arrangement showing the tail end on the UAV having a charging assembly and the charging and data transfer port that is affixed to the charging platform from FIG. 10, according to some embodiments of the present disclosure.

FIG. 13 describes method steps for managing UAV batteries, according to some embodiments of the present disclosure.

FIG. 14 describes method steps for managing UAV missions, according to some embodiments of the present disclosure.

FIG. 15 depicts an embodiment of a method for operating the Menatir Management System, according to some embodiments of the present disclosure.

### DETAILED DESCRIPTION OF THE INVENTION

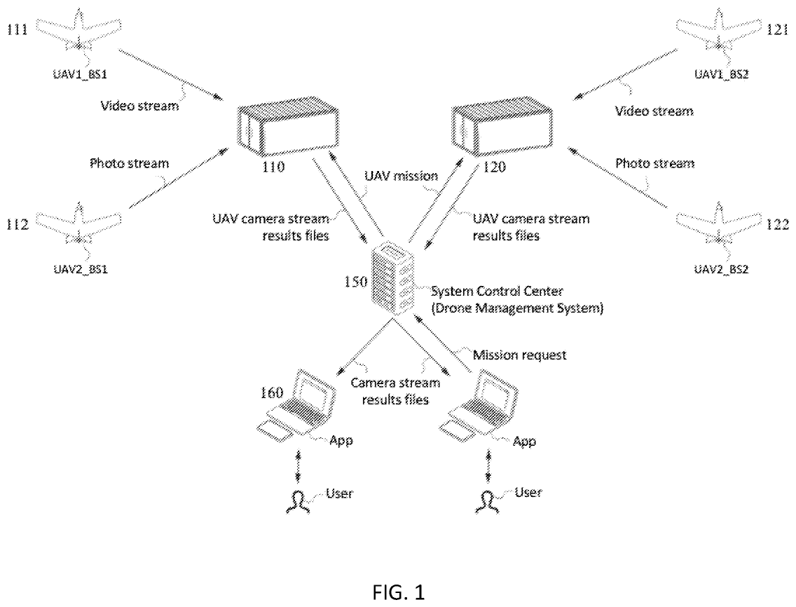

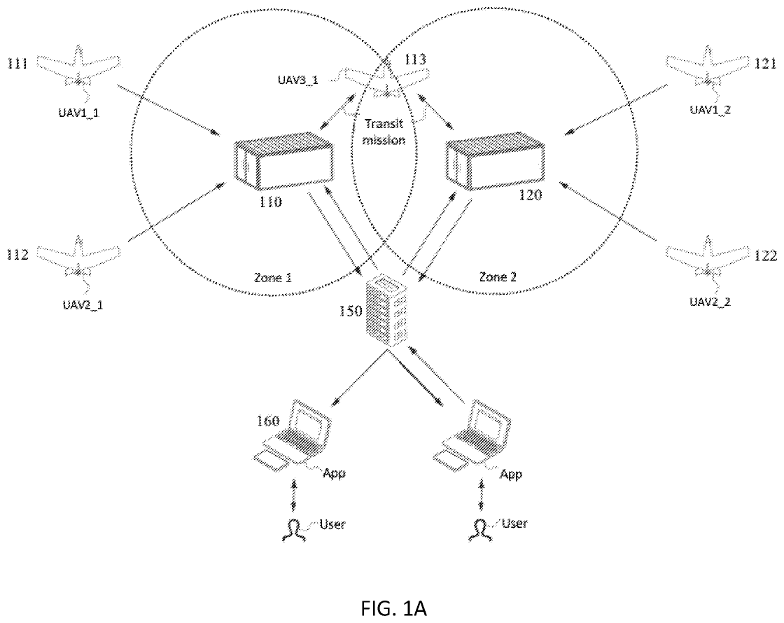

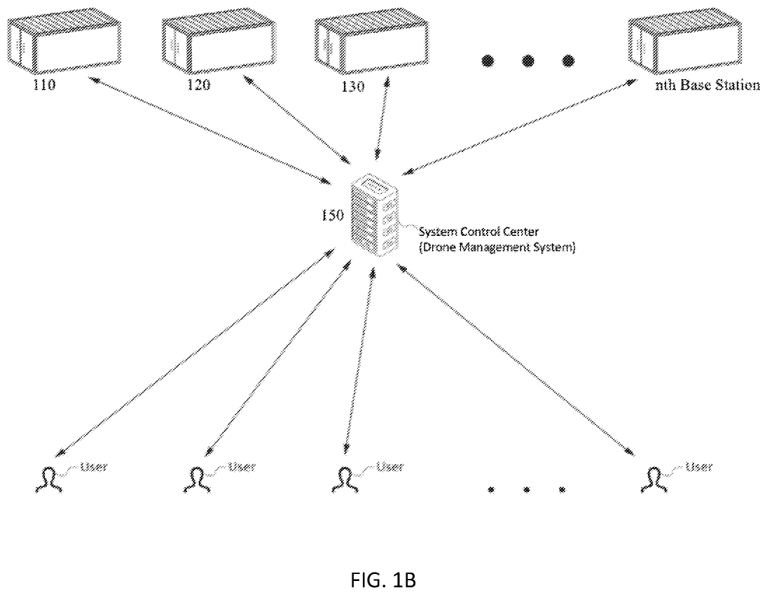

FIG. 1 depicts a detailed system diagram of an advanced UAV storage, deployment and movement system 100, which is designed to improve the efficiency of UAV operations. The UAV system 100 may comprise a network of UAV base stations 110 and 120, which are equipped with specialized infrastructure for housing, storing and charging of a plurality of UAVs. Each of the UAV base stations is capable of controlling and managing multiple UAVs, with base station 110 responsible for controlling UAVs 111 and 112, and base station 120 managing UAVs 121 and 122.

UAV storage, deployment and movement system 100 is designed to optimize the deployment and operation of these advanced UAVs. The base stations 110 and 120 are strategically located to cover large geographical areas and are equipped with state-of-the-art communication systems to ensure seamless transmission with the UAVs. The system enables the efficient management of multiple UAVs, allowing them to be quickly deployed and retrieved, and ensuring that they are fully charged and operational at all times. This ensures that the UAVs can perform their intended tasks with maximum efficiency and minimum downtime.

The UAV system 100 includes a plurality of UAVs that are configured to transport and use various payloads. These UAVs receive missions from their respective base stations 110 and 120, which control the UAVs' movements and operations. The system can support any number of UAVs and base stations, all of which are centrally controlled by a system control center 150. The system control center 150 includes the Menatir Management System (MMS), which is a UAV management system that enables the central access point to monitor and manage the UAVs and their missions.

In addition, the system includes a computer station 160 with cloud capabilities that allow multiple users to access and control the system application from anywhere. The cloud-based system provides users with real-time information on the UAVs' movements, locations, and operations, as well as the ability to adjust mission parameters on the fly. The UAVs are equipped with various sensors and communication devices that enable them to communicate with the base stations and the system control center. The UAV management system uses this data to optimize the UAVs' performance, including route planning, payload management, and battery usage. Overall, the system provides a flexible and efficient way to deploy and manage UAVs for a wide range of applications.

In FIG. 1A, the system comprises operational zones: Ops Zone 1 and Ops Zone 2, which are controlled by their respective base stations 110 and 120. These zones are part of the storage, deployment and movement system depicted in FIG. 1. The system includes multiple working zones, each corresponding to the number of base stations in the system. Each working zone is responsible for a specific area of operation and is controlled by its respective base station. The number of working zones and their corresponding base stations may vary depending on the specific needs and requirements of the system.

The UAV control system described in this embodiment is designed to manage the operation of multiple UAVs within distinct working zones. The working zones are organized into a plurality of overlapping areas, where each zone is managed by a corresponding base station. The base stations are responsible for accepting control over the UAVs that fall within their respective working zones.

The UAV management system is responsible for determining the assignment of working zones to base stations based on the mission requirements. As shown in FIG. 1A, the UAV 113 is being transferred from base station 110 to base station 120 to complete its mission. This transfer is carried out seamlessly through the coordinated effort of both base stations, with the receiving base station assuming control of the UAV once it enters its working zone.

Overall, the system is designed to efficiently manage the movement and operation of multiple UAVs across the various working zones, with the UAV management system playing a critical role in ensuring optimal mission execution.

FIG. 1B displays many base stations and many users connected to the system control center 150. Each of many users may have access to many base stations, as well as many users can have access to the many base stations determined. The system control center “controls” the connection with many base stations and many users, and it distributes and controls access to users to many base stations.

FIG. 1B illustrates the expanded capabilities of the system, with multiple base stations and users connected via the control system 150. The system control center manages the connections between the base stations and users, distributing and controlling access to the base stations as needed. This allows for seamless transitioning of UAVs between base stations, enabling each base station to control any number of UAVs and switch assignments and missions as needed.

The use of a central access point in the system control center provides several advantages for the interconnection of base stations. One such advantage is the ability to seamlessly transition any number of UAVs between any number of base stations by providing each base station control of any number of UAVs. Additionally, base stations can switch assignments and change missions, allowing for greater flexibility in the system. Another advantage is the ability for UAVs to continue their missions even if they are out of range of their assigned base station. UAVs can land at other bases and be replaced by another UAV from any number of base stations in the vicinity of the mission.

In some embodiments, multiple UAVs, such as UAVs 111 and 112, can be interconnected to other groups of UAVs, such as UAVs 121 and 122, via a designated base station. Furthermore, multiple UAV base stations can be interconnected to other groups of UAV base stations through the system control center 150.

Each UAV, such as UAVs 110, 120, 130 can be configured to communicate with any base station in order to send video streams and photos, or to receive new mission orders. Additionally, the UAV base stations can communicate with the system control center 150 to receive UAV mission logs and send UAV data results and files. The system control center can analyze the data and forward it to another base station to deploy at least one UAV on a new mission or complete an existing mission.

Upon completion of a mission, each UAV can be stored and charged simultaneously at their respective or reassigned base stations. This allows for more efficient management of the UAV fleet and ensures that they are ready for the next mission.

The system may include a GPS receiver and an obstacle detection system on each UAV, enabling the UAV to navigate autonomously and avoid obstacles. The system may also include a fail-safe mechanism to ensure safe operations in the event of system or component failure. The fail-safe mechanism may include a backup power source for the base stations and UAVs, as well as a redundant communication system to ensure constant communication between the UAVs, base stations, and system control center.

The system may be operated by trained personnel who can access the system application through the computer station 160 with cloud capabilities. The system application may provide real-time monitoring of UAV locations, statuses, and missions, as well as video feeds from the UAVs' cameras. The application may also allow users to assign and modify missions, manage and track inventory of UAVs and payloads, and generate reports on system performance and mission results.

In addition, the system may be designed with scalability in mind, allowing for the addition of new base stations and UAVs as needed to support expanding mission requirements. The system may also be customizable to suit specific mission needs and requirements.

Here are some of the critical advantages of having an interconnected system as shown in FIGS. 1, 1A, and 1B:

Seamless transitioning of UAVs. One of the main advantages of having base stations interconnected via the central access point in the system control center is that it enables seamless transitioning of any number of UAVs between any number of base stations. This is possible because each base station has control of any number of UAVs, which allows for the ability to switch assignments and change their missions. This means that if a UAV is out of range of its assigned base station, it can easily land at another base station and be replaced by another UAV from any number of base stations in the vicinity of the mission.

Improved mission effectiveness. By providing each base station control of any number of UAVs, the interconnected system allows for improved mission effectiveness. This is because the system can dynamically allocate and reallocate UAVs to different missions and working zones, based on the needs of the mission. This means that the system can respond quickly to changing mission requirements and optimize the use of available resources.

Enhanced communication and data sharing. The interconnected system also facilitates enhanced communication and data sharing between UAVs and base stations. Each of the UAVs is configured to communicate with any base station to send data results and files or receive new mission orders. The plurality of UAV base stations may be configured to communicate with the system control center 150 to receive UAV mission logs and send UAV camera stream results files, which can be analyzed and forwarded to another base station to deploy at least one UAV on a new mission or complete an existing mission. This means that the system can collect and analyze data in real-time, which can be used to optimize mission planning and improve mission outcomes.

Increased reliability and redundancy. The interconnected system also provides increased reliability and redundancy. Because each base station can control any number of UAVs, the system can operate even if one or more base stations are offline or malfunctioning. This means that the system can continue to operate and complete missions even if individual components fail.

Overall, the interconnected system depicted in FIGS. 1, 1A and 1B provides a number of advantages over known UAV systems. By providing seamless transitioning of UAVs, improved mission effectiveness, enhanced communication and data sharing, and increased reliability and redundancy, the system can optimize the use of available resources and improve mission outcomes.

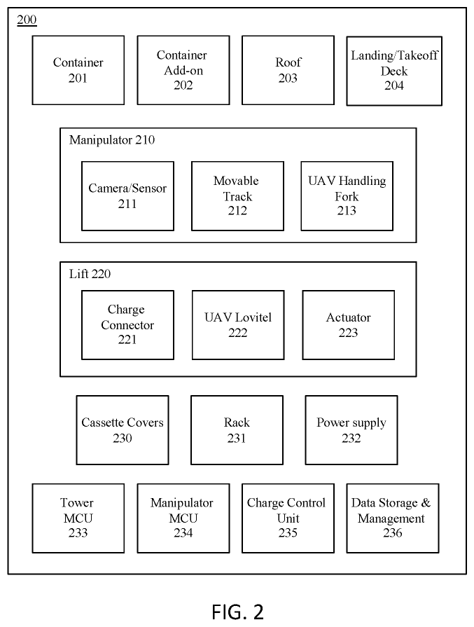

FIG. 2 shows a block diagram of the operational system for managing an UAV base station 200 in detail, according to some embodiments of the present disclosure. The UAV base station 200 comprises several physical components, including a container 201, container add-on 202, roof 203, a UAV landing or takeoff deck 204, cassette covers 230, an electronics rack unit 231, a power supply unit 232, a tower MCU 233, a manipulator MCU 234, and a charge control unit 235.

The base station further comprises a lift system 220, having a charge a connector 221 for recharging the UAVs, a UAV Lovitel 222 to provide support for the UAVs while it is being stored and/or recharged in a vertical position, and an actuator 223 to control the movement of the lifts or elevators used to move the UAVs between different levels of the housing container. The actuator is connected to a control system that receives input signals from a controller, which determines the desired position of the actuator.

The roof 203 is designed to open and close the top of the housing container 201, which is configured to store and charge a plurality of networked UAVs. The UAV landing or takeoff deck 204 is positioned immediately under the roof 203, providing a safe and secure landing spot for the UAVs. The container 201 further comprises HVAC units such as the air conditioning unit, which is employed to maintain a controlled temperature environment inside the housing container 201, and a heater, which is used to prevent the temperature from dropping below a predetermined level.

The electronics rack unit 231 is used to house and manage the electronic equipment needed for the operation of the UAVs, such as GPS, batteries, computers, and controllers. The power supply unit 232 is responsible for powering the container 201 and its various components, including for powering the charge control unit which is configured to recharge the UAVs, for using the lift, for powering the electronics rack unit 231, and for powering HVAC and heating units.

The manipulator MCU 234 is a microcontroller unit that manages the manipulator 210, which is responsible for receiving, sorting, and arranging the plurality of the UAVs inside cassette covers 230 positioned within the housing container 201. The manipulator 210 includes a camera or a sensor 211, a movable track 212, and a UAV lifting fork 213, all of which work together to determine the exact location of the UAVs once they land, move the manipulator in place, and grab the UAV to hoist it and move it about.

The tower MCU 233 is another microcontroller unit that controls the plurality of lifts or elevators 220, which are used to move the UAVs inside the housing container 201.

The charge control unit 235 manages the charging and recharging of the plurality of the UAVs, ensuring that they are ready to be deployed for their next mission.

It is important to note that the UAV base station 200 is designed to work seamlessly with other base stations and the system control center as shown in FIGS. 1, 1A and 1B, enabling the efficient distribution and control of the networked UAVs.

One of the critical advantages of the instantly disclosed UAV base station system as shown in FIG. 2 over other known systems is its ability to receive, store, and charge a plurality of networked UAVs in a secure and controlled environment. The roof 203 and housing container 201 provide protection against harsh weather conditions, ensuring the longevity and safekeeping of the UAVs. Additionally, the HVAC and heater ensure that the environment inside the container is maintained at a predetermined temperature, which is critical for the proper functioning of the UAVs.

Another advantage of the UAV base station 200 is the inclusion of the manipulator 210, which enables the receiving, sorting, and arrangement of the UAVs inside cassette covers within the housing container 201. The manipulator 210 is controlled by the manipulator MCU 234, which allows for precise and efficient handling of the UAVs.

The tower MCU 233 controls the plurality of lifts or elevators 220, which can transport the UAVs between different levels of the housing container 201. This feature allows for the efficient use of space within the container, which can be critical in situations where space is limited.

The charge control unit 235 manages the charging and recharging of the plurality of UAVs, ensuring that they are always ready for deployment. This feature eliminates the need for manual charging and reduces the time required for the UAVs to be ready for their next mission.

The camera or sensor 211 in the manipulator 210 enables precise determination of the location of the UAVs within the housing container 201. This information can be used to ensure that the UAVs are stored and arranged properly, reducing the risk of damage and ensuring that they are readily available for deployment. Additionally, the manipulator 210 is configured to help improve the efficiency and safety of the base station system.

Moreover, the base station 200 is designed to be modular and scalable. This allows for greater flexibility in terms of how the base station is configured and deployed, and can also help to reduce the risk of a single point of failure in the system.

In some embodiments, the tower MCU 233 may further control the charging or recharging of a plurality of UAVs, lowering, and raising of cassette covers 230, and opening and closing of the roof 203.

In some embodiments, the housing container 201 may be movable. In some embodiments, the base station 200 may control payloads of the plurality of networked UAVs and may be connected to the server. In some embodiments, the base station 200 may be connected to the system control center.

In certain embodiments of the present disclosure, the base station 200 may include a UAV data storage and management module 236, which is designed to manage and store the data generated by the UAVs. The data storage module 236 is implemented as a server that is always connected to the base station 200, and is responsible for storing all the data generated by the UAVs during their missions.

When the base station 200 is connected to the control system, the data storage module 236 temporarily stores the data generated by the UAVs and transfers them to the control system. This ensures that all the data is centralized and accessible by authorized personnel. In cases where the base station 200 loses connection to the control system, the data storage module 236 acts as the final storage location for the data generated by the UAVs.

The data storage and management module 236 is designed to ensure that the data generated by the UAVs is properly organized and easily accessible. The module uses advanced algorithms to categorize and prioritize the data based on their importance and relevance to the mission. The module also performs regular backups to ensure that the data is safe and secure in case of any system failures or disasters.

Additionally, the data storage and management module 236 is equipped with advanced security measures to ensure that the data generated by the UAVs is protected against unauthorized access, tampering, or theft. The module uses state-of-the-art encryption algorithms to secure the data in transit and at rest, and also implements strict access controls to limit the access of the data to authorized personnel only.

The UAV data storage and management module 236 is an integral part of the base station 200 and plays a crucial role in ensuring the successful operation of the UAV system. The module provides a centralized and secure storage location for the data generated by the UAVs, which enables the authorized personnel to access the data quickly and easily.

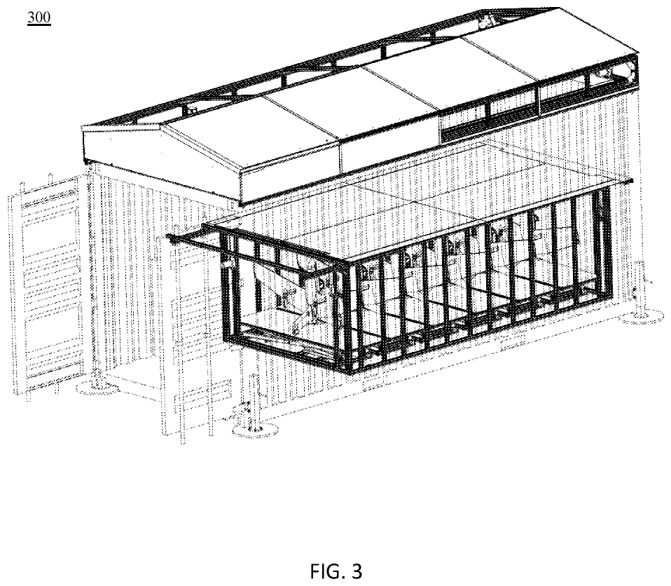

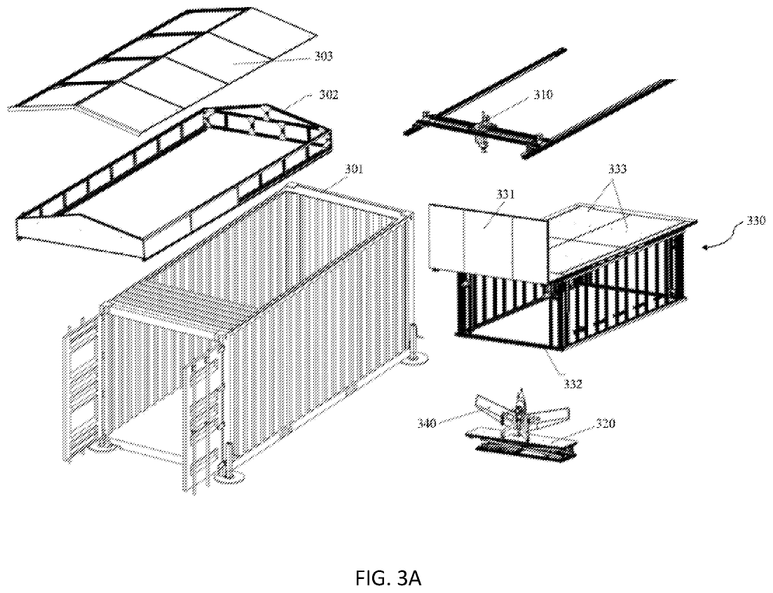

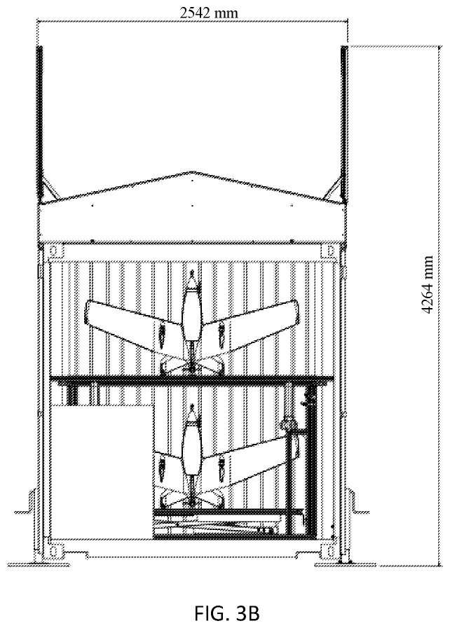

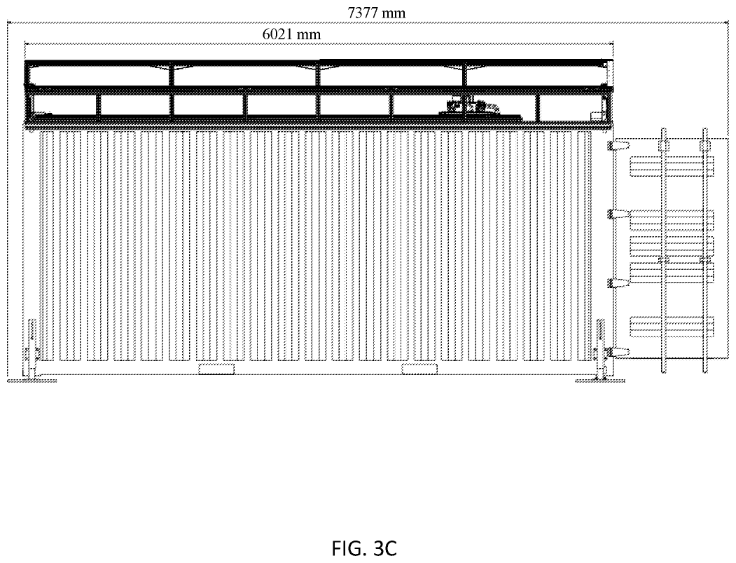

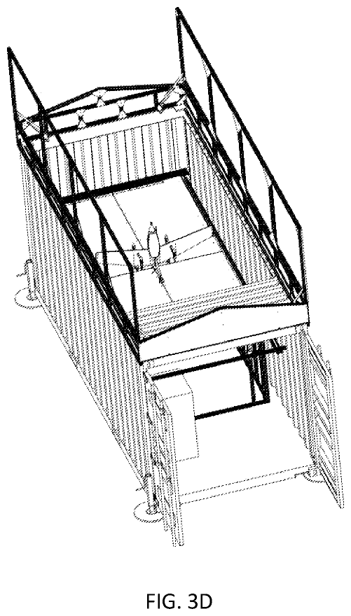

FIG. 3 is a 3D view of a container 300 for holding UAVs, according to some embodiments of the present disclosure. Further in FIG. 3A, the container 300 is broken down into main components comprising: a container shell 301, container add-on 302, the roof 303 which sits atop of the add-on 302, the manipulator 310, landing and takeoff platform 330, and UAVs 340 sitting on a lift 320.

The manipulator further comprises a partition 331, cassette frames 332, and cassette covers 333 to store and move the UAVs with high efficiency.

FIG. 3 is a three-dimensional view of the container 300 designed to hold UAVs, as described being part of the base station system above, according to several embodiments of the present disclosure. As shown in FIG. 3A, the container 300 comprises several key components, including a container shell 301, container add-on 302, a roof 303 positioned atop the add-on 302, a manipulator 310, a landing and takeoff platform 330, and several UAVs 340 placed on a lift 320 within the container.

The manipulator 310 is designed to provide efficient and precise control over the UAVs. It includes a partition 331 to separate the container 300 into various functional areas, cassette frames 332 to hold the UAVs, and cassette covers 333 to secure the UAVs in place during movement. The manipulator 310 allows for automated sorting and arrangement of the UAVs, enhancing the efficiency and effectiveness of the entire system.

The landing and takeoff platform 330 is located within the container 300, positioned under the roof 303. The platform 330 serves as a secure location for the UAVs to land and take off, while protecting them from external weather conditions and interference by being able to quickly open and close the roof 303. The lift 320 is designed to move the UAVs between the platform 330 and the cassette frames 332 in the manipulator 310. This eliminates the need for manual handling of the UAVs, reducing the risk of damage and increasing efficiency.

The container add-on 302 provides additional structural support for the container and serves as a base for the roof 303. The roof 303 is designed to be opened and closed as needed, allowing for easy access to the container 300 and its contents. This configuration offers a secure, organized, and efficient system for storing, sorting, and moving UAVs within the container 300.

FIG. 3B depicts a short side view and dimensions of a container housing one or more UAVs, according to some embodiments of the present disclosure. As can be seen in FIG. 3B, the UAVs may be organized inside the container in stacked or staggered configuration. The dimensions of the container 300 are 2542 mm wide and 4264 mm tall with the roof completely opened.

FIG. 3C depicts a long side view and dimensions of a container for holding UAVs, according to some embodiments of the present disclosure. The container 300 is 6021 mm when closed and 7377 mm with its doors opened.

FIG. 3D depicts a container in a 3D view, having its roof open while holding a UAV, according to some embodiments of the present disclosure. It is yet another configuration showing a UAV being lowered by the lift to be stored below.

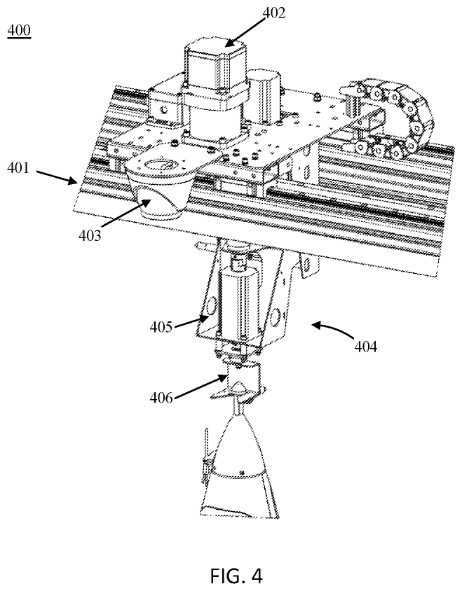

In FIG. 4, the UAV handling assembly 400 is designed to power the manipulator with high precision and accuracy. The assembly comprises a sturdy and durable steel plate 401, which serves as a foundation for the placement of a powerful stepper motor 402 and a camera or sensor 403. The stepper motor 402 is responsible for providing the necessary torque and speed to move the manipulator efficiently, while the camera or sensor 403 provides precise location information for each UAV to move the manipulator to the precise location of the UAV.

Beneath the steel plate 401, the UAV handling assembly 400 further includes a control box 405 that houses the electronics responsible for picking up the UAV with a handling fork 406. The control box 405 also provides power to the UAV lifting mechanism 404, which is responsible for physically moving the UAVs. The UAV handling fork 406 is used to grip and move the UAVs with precision, accuracy, and safety.

The handling assembly 400 ensures that the manipulator performs its functions seamlessly and with minimal error. It is designed to operate in a high-stress environment, and the components used in the assembly are carefully selected for their durability and reliability. The assembly is also designed for ease of maintenance and repair, ensuring that the manipulator remains functional at all times.

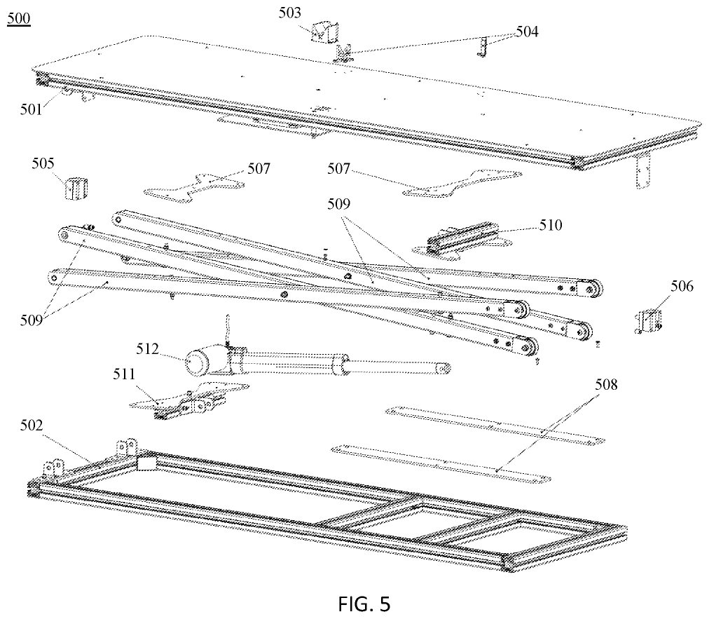

FIG. 5 illustrates a detailed view of the lift system designed for raising and lowering the UAVs within the container in accordance with some embodiments of the present disclosure. The lift system 500 is comprised of several components that work together in a synchronized fashion to enable the safe and efficient movement of the UAVs.

The lift system 500 is constructed of a lift upper frame 501 and a lift lower frame 502. The upper and lower frames are connected through the lift beams 509 fixed to the upper and lower steel plates 507 and 508 respectively. The lift system 500 is capable of managing one or more UAVs, and it is designed to support the weight of any number of UAVs being stored or recharged in a container.

In addition, the lift system 500 includes an upper linear bearing 505 and a lower linear bearing 506. These linear bearings work together to ensure the smooth movement of the lift beams 509. The lift system 500 also includes an UAV charging connector 503 that allows the UAVs to be charged during the lifting or lowering process. Furthermore, the lift system 500 incorporates a novel UAV Lovitel assembly 504 to guide the seating of the plane, and it is responsible for supporting the UAVs during the lifting and lowering process.

The lift system 500 further comprises an actuator 512 that is mounted on the upper and lower actuator mounting brackets 510 and 511. The actuator 512 is used to control the movement of the lift beams 509 and to ensure that the UAVs are lifted or lowered in a smooth and controlled manner.

Overall, the lift system 500 is an integral component of the container that ensures that the UAVs are safely transported and stored. The lift system 500 is designed to operate with high efficiency and accuracy, and it plays a critical role in enabling the UAVs to be transported and deployed as efficiently as possible.

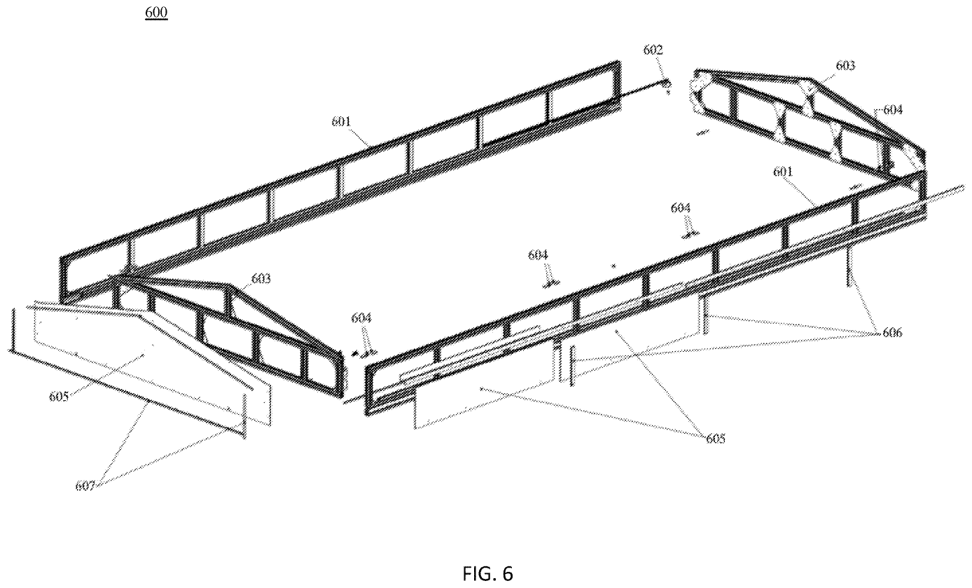

FIG. 6 illustrates a detailed view of the container add-on component that provides additional support to the roof in some embodiments of the present disclosure. The roof add-on 600 consists of several components, including a longitudinal frame 601, angle bracket 602, cross frame 603, roof hanger 604, aluminum plate 605, connection profile 606, and end profile 607. The longitudinal frame 601 and cross frame 603 are made of high-strength steel material and are assembled with the angle brackets 602 to form a rigid structure. The roof hanger 604 is mounted on the top of the longitudinal frame 601 and is designed to hold the roof panel in place.

The aluminum plate 605 is connected to the longitudinal frame 601 and provides a surface for the roof panel to rest on. The connection profile 606 is attached to the end of the aluminum plate 605 and the end profile 607 is mounted on the outer edge of the connection profile 606. The end profile 607 functions as a stopper to prevent the roof panel from sliding off the aluminum plate 605 during operation.

The roof add-on 600 plays a crucial role in providing additional strength and rigidity to the container frame. It ensures that the container can withstand the weight of multiple UAVs during landing and takeoff. Additionally, the increased height of the container allows for a more convenient and safer operation of the UAVs. The roof add-on 600 also helps to support the roof panel when it is closed, ensuring that the container remains secure during transportation.

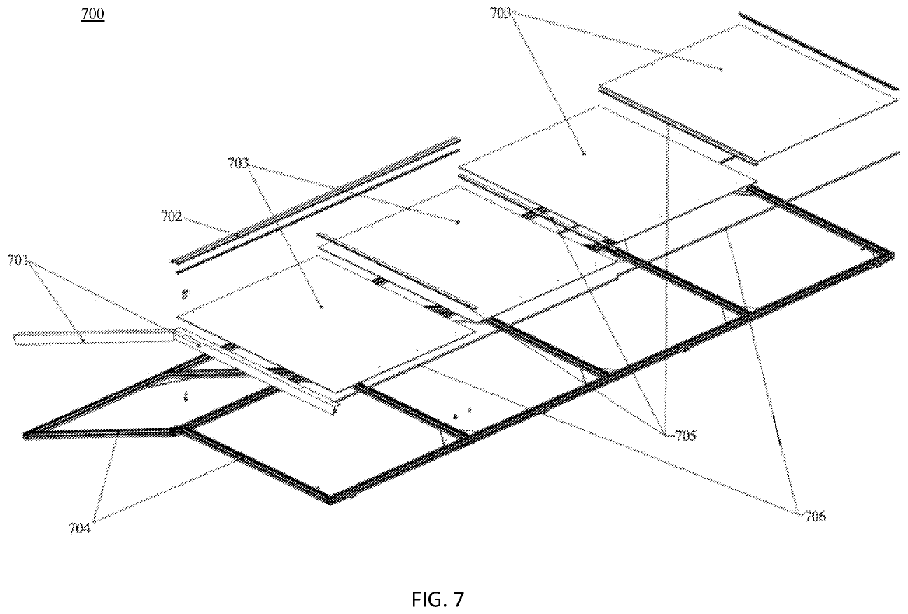

FIG. 7 is a depiction of the container roof and its parts, according to some embodiments of the present disclosure. The roof 700 is designed to securely and stably enclose the UAVs in the container during handling and storage. The roof comprises various components, including aluminum angle 701, roof ridge 702, and several aluminum plates 703 separated from each other by connection profiles 705. End profiles 706 are included to provide additional support and rigidity to the overall structure of the roof.

The aluminum-made angle 701 is designed to provide additional support and rigidity to the roof. The roof ridge 702 functions to ensure that water and debris slide off the roof, preventing damage to the UAVs inside the container. The aluminum plates 703 are separated by connection profiles 705, which function to keep the plates securely in place and prevent movement and weakening of the roof. The end profiles 706 also play a critical role in keeping the roof structure rigid and secure, preventing any potential damage to the UAVs inside the container.

Overall, the roof 700 is an important component of the container system as it provides a secure and stable enclosure for the UAVs during transportation and storage. The various components of the roof work together to ensure that the UAVs are protected from potential damage, and that the overall structure of the container is rigid and secure.

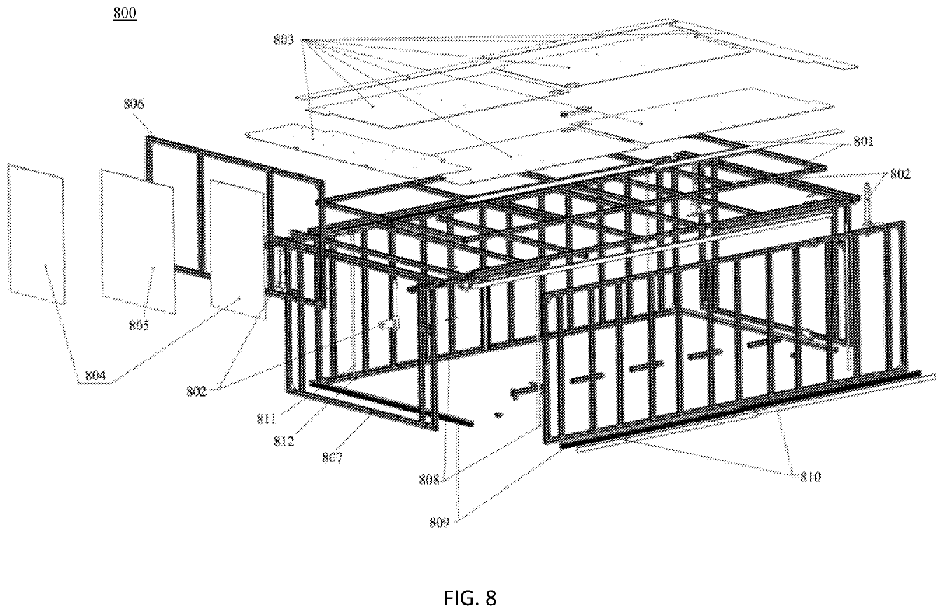

FIG. 8 is a depiction of the landing and takeoff platform, according to some embodiments of the present disclosure. The platform 800 is designed to facilitate the efficient and safe landing and takeoff of multiple UAVs. The platform consists of several cassette frames 801 that provide support and storage for the UAVs. At least four actuators 802 are integrated into the platform to provide lift and lowering capabilities for the UAVs. The actuators are connected to the cassette frames and are controlled by the UAV handling assembly to ensure precise and safe movement of the UAVs during takeoff and landing.

The platform 800 is constructed with several top aluminum plates 803 and side aluminum plates 804, which provide additional support and rigidity to the structure. A plurality of clear plates 805 are used to separate the individual cassette frames and are held in place by a large partition frame 806. Cross frames 807, longitudinal frames 808, and conduit profiles (U 40×40) 809 are used to provide more structure, strength, and rigidity to the platform, ensuring that it can withstand the weight and movement of the UAVs during takeoff and landing.

The platform 800 also comprises a lid profile D40 810, which provides additional wall security. A linear guide 811 and linear shaft holder 812 are integrated into the platform to ensure smooth and precise movement of the landing and takeoff platform during opening and closing. The platform is designed to be operated remotely and is controlled by the base station, which communicates with the manipulator and the UAV handling assembly to coordinate the safe and efficient movement of the UAVs.

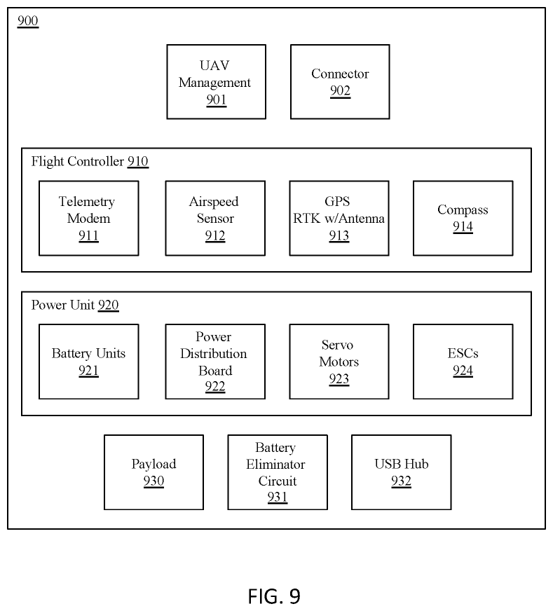

FIG. 9 illustrates the operating system for the UAV, a vertical lift-off UAV system, in detail. The system 900 comprises several components, including UAV management software 901, connector 902, flight controller 910, power unit 920, payload 930, battery eliminator circuit 931, and USB hub 932.

The UAV management software 901 functions as a set of software additions to the main firmware of the UAV. The software is responsible for engine control, modifying the trajectory of the transition from horizontal flight to vertical flight, and automating the choice of approach trajectory, taking into account weather and landscape conditions to ensure safe, efficient, and stable flight operations.

The flight controller 910 is a critical component in the UAV operating system, encompassing various sensors such as telemetry modem 911, airspeed sensor 912, GPS RTK with antenna 913, and compass 914. The power unit 920 consists of multiple battery units 921, a power distribution board 922, and several servo motors 923 powering multiple ESCs 924.

UAVs are designed for intelligent operation and communication with each other and the plurality of base stations. These UAVs can operate independently or in a coordinated manner to complete assigned missions. The base station defines a work area for each UAV associated with it, configuring the UAV to operate within the designated airspace around its base station and execute a mission within this area.

In cases where a mission is not found within the radio frequency range of any base station or is located in the overlap zone of two or more base stations, the user instructs the system and UAVs to share the flight task among several base stations and assigned UAVs. Each UAV's area of responsibility encompasses a portion of the airspace around it, wherein the UAV's flight task is set automatically. The area of responsibility also includes a spare landing ground and waiting area.

The spare landing ground serves as a pre-prepared location for Tailsitter-type UAVs with well-defined coordinates, used for emergency landings in cases of base station failure, onboard equipment failure, adverse weather conditions, or other emergency situations. The waiting area is a designated airspace within the base station used for organizing traffic when landing multiple UAVs simultaneously.

The formation of custom flight tasks occurs in semi-automatic mode, where the user creates the mission while the first and third parts are automatically selected from a list of pre-created routes. These routes are established during the base station installation process, taking into account landscape features, airspace organization, obstacles, and weather conditions.

Service flight tasks include test flights within the base station, migration of a UAV from one base station to another, and orthophoto mapping within the area of responsibility. The UAV operating system is designed to enable efficient and effective mission execution in various environments while ensuring safety and reliability.

The UAV system presents a number of compelling advantages over traditional UAV systems. Here are some of the key benefits:

Increased efficiency: UAVs are designed to operate autonomously or as a pack to complete assigned missions, eliminating the need for constant human intervention. This allows the system to perform tasks faster and more efficiently than traditional UAV systems, resulting in lower operational costs and increased productivity.

Enhanced safety: The UAV system is designed with safety in mind. The system automatically defines the area of work for each UAV, and each UAV is configured to operate within its designated airspace. The system also includes a spare landing ground and a waiting area to minimize the risk of accidents or emergencies. Additionally, the system's telemetry modem, airspeed sensor, GPS RTK, and compass help ensure accurate and safe operation of the UAV.

Flexibility: The UAV system is highly customizable and can be configured to meet a wide range of needs. The system allows users to define their own areas of work and create custom flight tasks in a semi-automatic mode. This flexibility makes the UAV system ideal for a variety of applications, including surveillance, inspection, mapping, and more.

Cost-effective: The UAV system is designed to be cost-effective, with a modular and scalable design that allows users to add or remove components as needed. The system's efficient operation and autonomous capabilities also help reduce operational costs over time.

Improved data quality: The UAV system is equipped with a range of sensors and cameras that allow for high-quality data collection and analysis. The system's orthophoto terrain feature, for example, allows for highly accurate mapping and terrain analysis, while the payload system has a universal plug for all types of payloads, and can be further configured to carry a variety of sensors and cameras for different applications.

The UAV system offers a range of compelling advantages over traditional UAV systems, including increased efficiency, enhanced safety, flexibility, cost-effectiveness, and improved data quality. These benefits make the UAV system an ideal choice for a wide range of applications, from surveillance and inspection to mapping and beyond.

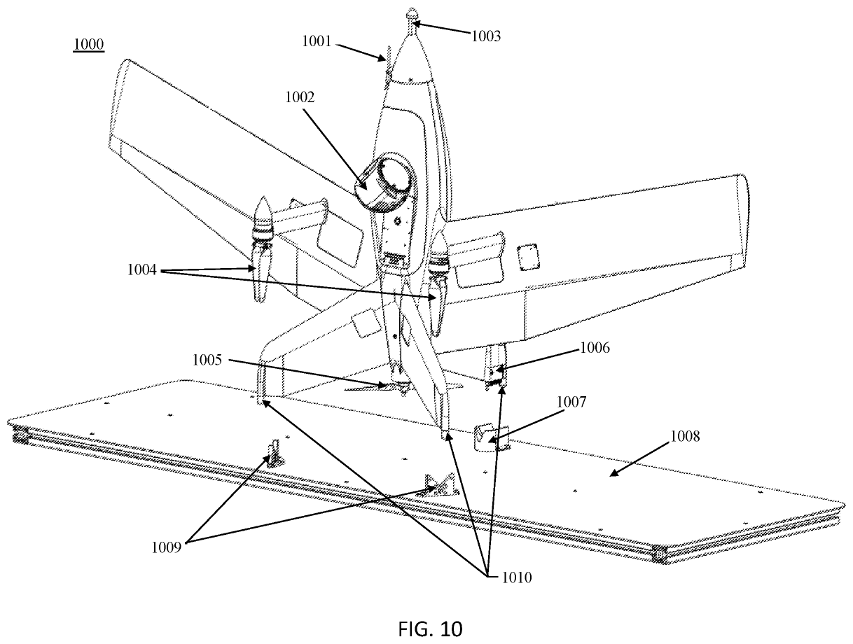

FIG. 10 depicts the UAV and a charging platform, according to some embodiments of the present disclosure. The UAV 1000 is composed of several structural components such as an airspeed sensor 1001, payload compartment 1002, and a hooking rod 1003 for lifting the UAV by the manipulator. The UAV 1000 includes a fuselage body and a pair of wings attached to the sides of the middle section of the fuselage. There are four folding propellers 1004 in total, with two propellers attached to the top and two attached to the bottom of each wing, and extending up at a 90° angle extending out from the top of the wing. The UAV also has a rear propeller 1005 affixed to the tail end of the fuselage body. Additionally, the UAV 1000 contains a charging connector 1006 attached to the top of the vertical stabilizer. The UAV further comprises supporting legs 1010 that provide balance to the UAV when it is grounded and seated in a vertical orientation.

The charging platform 1008 comprises a charging and data transfer port 1007, and at least three UAV Lovitels 1009 to support each of the three vertical stabilizers on the back of the UAV. Each folding propeller 1004 may be configured to provide vertical thrust, and the rear propeller 1005 has been configured to provide vertical thrust at takeoff, it can be used for horizontal flight, and add power during landing. In some embodiments, the charging and data transfer port 1007 includes electronics to charge the UAV 1000 and for data transfer.

When the UAV 1000 needs to be charged, it is positioned above the charging platform 1008. The three UAV Lovitels 1009 on the platform 1008 support the three vertical stabilizers on the back of the UAV 1000, while the supporting legs 1010 of the UAV are seated on the platform's surface. The charging connector 1006 on the UAV is then connected to the charging and data transfer port 1007 on the charging platform. The port 1007 is equipped with the necessary electronics to charge the UAV's battery and to transfer data.

This charging platform provides several advantages for the UAV system. Firstly, the UAV's battery life is a critical aspect of its operation. With the charging platform, the UAV can be charged quickly and efficiently without any need for manual intervention. Secondly, the charging platform enables the UAV to be charged while in its vertical landing position. This is particularly advantageous as it allows the UAV to be charged even in confined spaces, such as in urban areas or in areas where there is limited landing space. Lastly, the charging and data transfer port on the platform provides a convenient and reliable way to transfer data to and from the UAV, such as mission data or flight telemetry, which is crucial for efficient mission planning and execution.

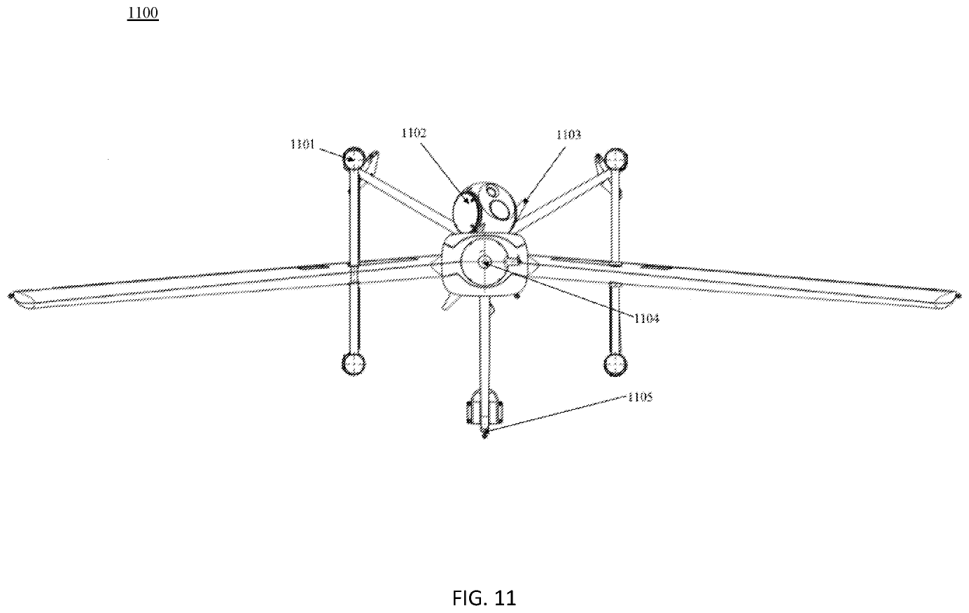

FIG. 11 illustrates the UAV from a top-down perspective, as per the present disclosure. The UAV features a quadrotor configuration with four folding propellers 1101 oriented in a preferred manner to ensure stability and maneuverability during flight. The UAV also includes a payload section 1102 to accommodate various payloads, a rear propeller 1103 for additional thrust and stability, and a hooking rod 1104 for picking up and moving the UAV as necessary. The charging connector 1105 is also present, serving to facilitate charging and data transfer of the mission logs.

In particular, the quadrotor configuration of the UAV enables stable and efficient flight, with each propeller operating in tandem to provide lift and control. The folding propellers 1101 are carefully oriented to ensure proper balance during flight, with pitch, roll, and yaw movements controlled by adjusting the speeds of the individual propellers. The payload section 1102 is designed to accommodate various payloads, with weight distribution carefully considered to ensure optimal stability during flight. The rear propeller 1103 provides additional thrust and stability, compensating for the rotational force generated by the main rotors. The hooking rod 1104 serves as a useful tool for moving the UAV, while the charging connector 1105 enables efficient charging and data transfer of the mission logs.

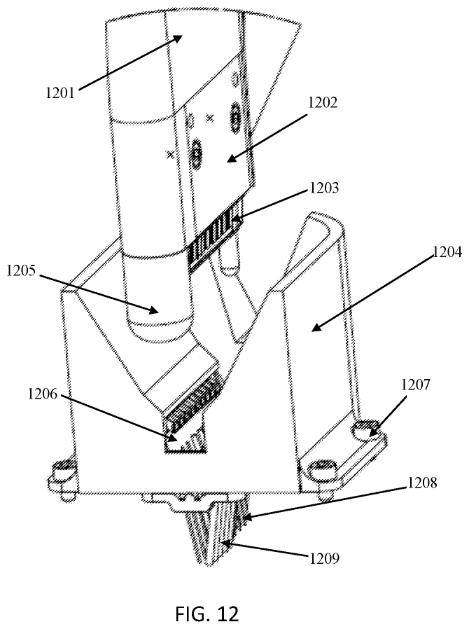

FIG. 12 depicts a detailed view of the charging assembly of the UAV in accordance with some embodiments of the present disclosure. The charging assembly 1202 is positioned within the rear vertical stabilizer wing 1201 of the UAV and incorporates charging contacts 1203 to enable efficient charging and data transfer.

When the UAV lands inside the container, the angled geometry of the charging receptor 1204 guides it into the charging nest 1206, where the charging assembly 1202 on the UAV is aligned with the charging receptor 1204 to allow for recharging and data transfer through specialized wiring arrangements. The charging nest 1206 is secured to the charging platform, as illustrated in FIG. 10, through bolts 1207, ensuring robust stability of the aircraft while it is being charged and/or stored in a vertical orientation supported by the supporting legs 1205.

The charging nest 1206 is equipped with a dedicated wiring arrangement that facilitates swift and efficient charging and data transfer of the UAVs. The wiring arrangement includes thick wires 1208 for data transfer and thin wires 1209 for electrical transfer. The thick wires are designed to allow for swift and reliable data transfer, while the thin wires are optimized for efficient electrical transfer during the charging process. This charging system is intended to minimize downtime for the UAVs, ensuring their continuous operation.

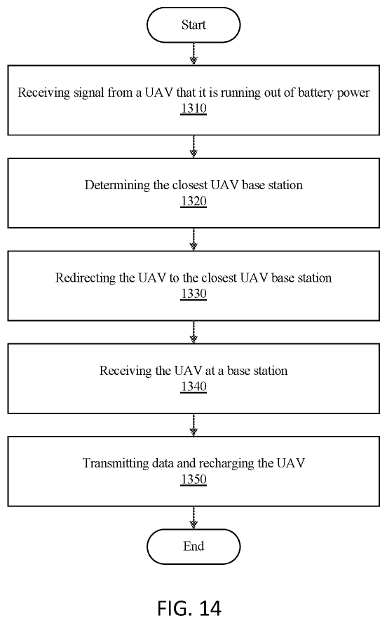

FIG. 13 outlines a detailed method for managing UAV battery power in accordance with some embodiments of the present disclosure. The method involves the following steps:

Step 1: Receiving Signal from UAV that Battery Power is Running Low 1310. In this step, the base station receives a signal from a UAV indicating that its battery power is running low. The signal could be transmitted by the UAV itself or by an automated battery monitoring system that is integrated into the UAV.

Step 2: Determining the Closest UAV Base Station 1320. Once the base station receives the signal, it determines the location of the closest UAV base station to the UAV's current position. This is achieved using various location-based technologies such as GPS or other satellite-based navigation systems. The distance to the base station is also taken into account during this step.

Step 3: Redirecting the UAV to the Closest UAV Base Station 1330. After determining the location of the closest base station, the base station redirects the UAV to the identified base station. This could involve transmitting a new flight plan to the UAV or providing remote control to the operator to redirect the UAV manually.

Step 4: Receiving the UAV at the Base Station 1340. Once the UAV reaches the designated base station, it is received and secured by the ground crew. The crew can retrieve any data collected by the UAV during the mission and perform a visual inspection of the UAV to ensure that it is in good condition.

Step 5: Transmitting Data and Recharging the UAV 1350. After receiving the UAV, the ground crew initiates the data transfer and charging process. The UAV is connected to a charging dock, which uses a specialized charging system to recharge the UAV's batteries quickly and efficiently. During this process, the data collected by the UAV is transmitted to the base station for further analysis and processing. Once the charging and data transfer process is complete, the UAV is ready for the next mission.

This method provides an efficient way to manage the battery power of the UAVs, ensuring that they remain operational with minimal downtime due to battery issues.

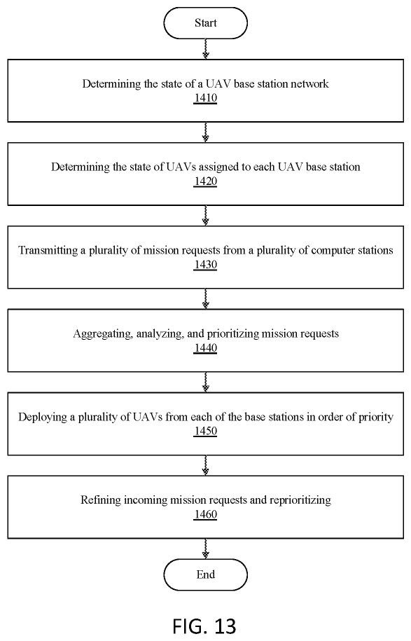

FIG. 14 depicts a detailed method for managing UAV missions in accordance with some embodiments of the present disclosure. The method consists of a series of steps designed to efficiently and effectively manage the UAV fleet.

Step 1: Determining the State of the UAV Base Station Network 1410. The first step in managing UAV missions involves assessing the status of the UAV base station network. This step involves monitoring the connectivity and status of the base stations to ensure that the UAVs can receive and transmit data and commands.

Step 2: Determining the State of UAVs Assigned to Each UAV Base Station 1420. The second step in the method involves evaluating the state of the UAVs assigned to each base station. This step ensures that each base station has a sufficient number of operational UAVs to complete the assigned missions.

Step 3: Transmitting Mission Requests 1430. The third step in the method is transmitting mission requests from a plurality of computer stations. These requests can include a variety of parameters, such as mission type, priority, location, and payload.

Step 4: Aggregating, Analyzing, and Prioritizing Mission Requests 1440. The fourth step involves aggregating, analyzing, and prioritizing the mission requests received in step three. This step is critical to ensure that mission requests are addressed efficiently, and the UAV fleet is utilized effectively.

Step 5: Deploying UAVs from Each Base Station in Order of Priority 1450. Once mission requests have been analyzed and prioritized, the next step is deploying the UAVs from each base station in order of priority. This step ensures that the most urgent missions are addressed first and that the UAVs are utilized efficiently.

Step 6: Refining Incoming Mission Requests and Reprioritizing 1460. The final step in the method involves refining incoming mission requests and reprioritizing the missions. This step ensures that the UAV fleet is utilized efficiently and that the most urgent missions are addressed first. Overall, this method for managing UAV missions ensures that the UAV fleet is utilized effectively and efficiently. By regularly monitoring the status of the base station network and UAVs, analyzing mission requests, and deploying UAVs in order of priority, this management system minimizes downtime and ensures that missions are completed as efficiently as possible.

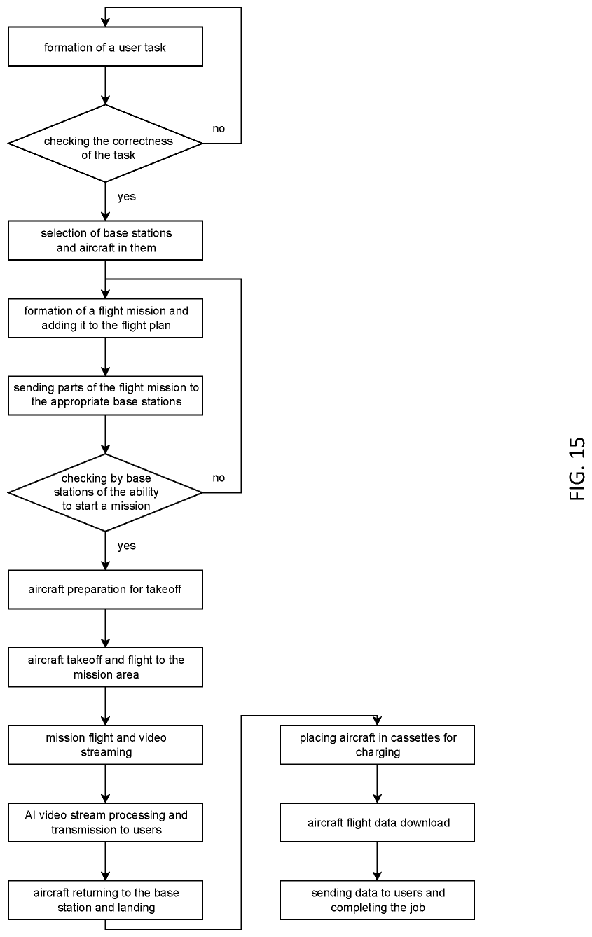

FIG. 15 depicts an embodiment of a method for operating an Menatir Management System as disclosed, the method comprising the steps of receiving a user-generated task, which includes a flight zone, payload, flight time, and optionally post-processing of received data, such as an orthophoto plan and data analysis. Upon acceptance of the user task by the system control center, the correctness of the task is checked and added to the flight schedule managed by a scheduler.

A flight mission is then formed and transmitted to a base station, which initiates the mission through a series of steps, including an aircraft check, automatic selection of the exit route from the area of responsibility of the base station based on wind strength and direction, raising the cassette with the aircraft, setting the aircraft manipulator to the starting point, and opening the base station roof.

Following a pre-flight check, the aircraft takes off and levels itself, flying along the exit route and towards the work area. The aircraft executes the user task and optionally transmits video from the aircraft to the base station, which then forwards the video to the user. The aircraft exits the work area and returns to the base station, where it checks the validity of the approach route and, if necessary, rewrites it. Upon landing at the base station, the aircraft is captured by a manipulator, installed in the cassette, and its battery is charged.

Useful information is sent from the aircraft to the base station server, where it is packaged and sent to the system control center and subsequently to the user. Optionally, the system control center may generate a task for post-processing information, and the processed information is sent to the user. The described method enables efficient UAV management and 24/7 operation of UAVs assigned to a plurality of base stations worldwide.

### WORKING EXAMPLES

The following 10 missions represent the preferred embodiments of the instantly disclosed interconnected UAV and base stations systems.

### Mission 1: Comprehensive Large-Scale Area Monitoring and Analysis.

The user requests an extensive and multifaceted mission to survey a vast area of 10,000 hectares, capturing high-resolution orthophoto maps (normal and multispectral), atmospheric conditions, and a video stream with AI processing for fire detection. Upon receiving the request, the advanced UAV system evaluates its feasibility and, once confirmed, selects the appropriate base stations and aircraft required for optimal execution (see Table below).

The system autonomously generates flight missions and transmits them to the base stations, considering the launch sequence for each aircraft involved. Base stations program the respective UAVs and initiate the launch process, which takes a maximum of 10 minutes per aircraft. This includes base station and aircraft status checks, aircraft positioning at the take-off site, and pre-flight inspections.

The UAVs take off and reach their working altitude of 500 meters, proceeding to their designated mission areas within 7 minutes. Upon arrival, the aircraft commenced data collection and analysis. UAVs with video cameras stream footage to the system control center in the Menatir Management System, where AI processes the data and forwards it to the user.

Simultaneously, UAVs equipped with cameras and multispectral cameras capture images of the area, while those with atmospheric sensors relay precise measurements to the user, maintaining an accuracy of approximately 3 cm. The comprehensive data collection process takes 8 hours to cover the entire area, with individual aircraft processing areas ranging from 200 to 2,000 hectares based on required accuracy.

### Mission 2: Consistent Fire Monitoring and Alert System.

The user requests a recurring fire monitoring mission for a smaller area of 500 hectares, with a stable schedule set at once per week for 20-hour durations. The advanced UAV system assesses the feasibility of the task, and upon confirmation, selects suitable base stations and aircraft for its completion (see table below).

The system autonomously develops flight missions and sends them to the base station, taking into account the minimum delay between aircraft transmitting video streams. The base station programs the first aircraft and initiates the launch process. Upon reaching the mission area, the UAV activates its video transmission to the system control center in the Menatir Management System, where AI processes the data for fire detection and sends the information to the user.

Each UAV has an operational flight time of approximately 1.5 to 2 hours, with around 100 minutes of active working time. The base station prepares and launches the subsequent UAVs in a synchronized manner, ensuring a seamless transition between video stream sources in under a minute. This mission requires the alternating use of three aircraft for continuous and effective fire monitoring.

### Mission 3: Precision Agriculture and Crop Health Management.

The user requests a mission designed to optimize agricultural practices and monitor crop health over a specified area ranging from 200 to 2,000 hectares. The advanced UAV system assesses the feasibility of the task and, upon confirmation, selects suitable base stations and aircraft to meet the mission requirements (see table below). The UAV fleet, consisting of 2 to 6 aircraft, is equipped with multispectral cameras, thermal cameras, and AI processing capabilities, enabling precise data collection and analysis for crop health, irrigation management, and yield estimation. The UAVs are managed by a single base station or a network of up to 2 base stations spaced 2 to 10 km apart, ensuring continuous operation and data collection to support efficient and sustainable agricultural practices.

Upon receiving the request, the system autonomously generates flight missions and sends them to the base stations. The base stations program the respective UAVs and initiate the launch process. The UAVs take off, reach their working altitude, and proceed to their designated mission areas to begin data collection.

Throughout the mission, UAVs with multispectral and thermal cameras capture images to assess crop health, detect pest infestations, and evaluate irrigation systems. AI processes the collected data and provides actionable insights to the user for informed decision-making in real-time. The mission operates with continuous 24/7 monitoring, allowing farmers and land managers to make timely interventions and adjustments to their agricultural practices, resulting in improved resource management, crop health, and overall productivity.

### Mission 4: Wildlife Conservation and Monitoring.

The user requests a mission to monitor and protect wildlife in a designated area ranging from 500 to 5,000 hectares. The advanced UAV system assesses the feasibility of the task and, upon confirmation, selects suitable base stations and aircraft to meet the mission requirements (see table below). The UAV fleet, consisting of 2 to 4 aircraft, is equipped with high-resolution cameras, thermal cameras, and AI processing capabilities for accurate wildlife tracking, habitat assessment, and population estimation. The UAVs are managed by a network of 1 to 3 base stations spaced 2 to 20 km apart, ensuring continuous operation and data collection to support effective wildlife conservation efforts.

Upon receiving the request, the system autonomously generates flight missions and sends them to the base stations. The base stations program the respective UAVs and initiate the launch process. The UAVs take off, reach their working altitude, and proceed to their designated mission areas to begin data collection. Throughout the mission, UAVs with high-resolution and thermal cameras capture images and videos of wildlife populations, habitats, and movements. AI processes the collected data and provides valuable insights to the user, enabling informed decision-making and targeted conservation efforts. The mission operates with continuous 24/7 monitoring, allowing conservationists and wildlife managers to make timely interventions, assess habitat health, and ensure the protection of various species and their ecosystems.

### Mission 5: Infrastructure Inspection and Maintenance.

The user requests a mission to inspect and maintain critical infrastructure elements, such as bridges, pipelines, powerlines, and wind turbines, spread across an area ranging from 10 to 100 hectares. The advanced UAV system assesses the feasibility of the task and, upon confirmation, selects suitable base stations and aircraft to meet the mission requirements (see table below).

The UAV fleet, consisting of 1 to 2 aircraft, is equipped with high-resolution cameras, LiDAR sensors, and AI processing capabilities for accurate infrastructure assessment and defect detection. The UAVs are managed by a single base station, ensuring continuous operation and data collection to support efficient infrastructure inspection and maintenance efforts.

Upon receiving the request, the system autonomously generates flight missions and sends them to the base station. The base station programs the respective UAVs and initiates the launch process. The UAVs take off, reach their working altitude, and proceed to their designated mission areas to begin data collection. Throughout the mission, UAVs with high-resolution cameras and LiDAR sensors capture images and point cloud data for detailed infrastructure analysis. AI processes the collected data and identifies potential defects, hazards, and maintenance needs. This information is provided to the user for informed decision-making and targeted maintenance efforts.

The mission operates with continuous 24/7 monitoring, allowing engineers and infrastructure managers to conduct timely inspections, schedule maintenance, and ensure the safety and longevity of critical infrastructure elements.

### Mission 6: Coastal and Marine Ecosystem Monitoring.

The user requests a mission to monitor and assess coastal and marine ecosystems in a designated area ranging from 1,000 to 10,000 hectares. The advanced UAV system assesses the feasibility of the task and, upon confirmation, selects suitable base stations and aircraft to meet the mission requirements (see table below). The UAV fleet, consisting of 3 to 6 aircraft, is equipped with high-resolution cameras, multispectral cameras, and AI processing capabilities for accurate data collection and analysis of marine habitats, water quality, and coastal erosion. The UAVs are managed by a network of 1 to 4 base stations spaced 5 to 25 km apart, ensuring continuous operation and data collection to support effective coastal and marine ecosystem monitoring efforts.

Upon receiving the request, the system autonomously generates flight missions and sends them to the base stations. The base stations program the respective UAVs and initiate the launch process. The UAVs take off, reach their working altitude, and proceed to their designated mission areas to begin data collection. Throughout the mission, UAVs with high-resolution and multispectral cameras capture images and data related to marine habitats, water quality, and coastal erosion. AI processes the collected data and provides valuable insights to the user, enabling informed decision-making and targeted conservation efforts. The mission operates with continuous 24/7 monitoring, allowing coastal managers, environmental scientists, and marine conservationists to make timely interventions, assess ecosystem health, and ensure the protection of coastal and marine habitats.

### Mission 7: Disaster Response and Relief.

The user requests a mission to provide immediate response and relief support in the aftermath of a natural disaster or emergency situation in a designated area ranging from 2,000 to 20,000 hectares. The advanced UAV system assesses the feasibility of the task and, upon confirmation, selects suitable base stations and aircraft to meet the mission requirements (see table below). The UAV fleet, consisting of 4 to 8 aircraft, is equipped with high-resolution cameras, thermal cameras, and AI processing capabilities for accurate damage assessment, search and rescue operations, and situational awareness. The UAVs are managed by a network of 2 to 5 base stations spaced 10 to 30 km apart, ensuring continuous operation and data collection to support effective disaster response and relief efforts.

Upon receiving the request, the system autonomously generates flight missions and sends them to the base stations. The base stations program the respective UAVs and initiate the launch process. The UAVs take off, reach their working altitude, and proceed to their designated mission areas to begin data collection. Throughout the mission, UAVs with high-resolution and thermal cameras capture images and videos of affected areas, identify potential hazards, and locate survivors. AI processes the collected data and provides valuable situational awareness to the user, enabling informed decision-making and targeted response efforts. The mission operates with continuous 24/7 monitoring, allowing disaster response teams and emergency managers to make timely interventions, assess the extent of the damage, and ensure the safety and well-being of affected populations.

### Mission 8: Infrastructure Inspection and Monitoring.

The user requests a mission to inspect and monitor critical infrastructure, such as bridges, roads, power lines, and pipelines, in a designated area ranging from 1,000 to 10,000 hectares. The advanced UAV system assesses the feasibility of the task and, upon confirmation, selects suitable base stations and aircraft to meet the mission requirements (see table below). The UAV fleet, consisting of 3 to 6 aircraft, is equipped with high-resolution cameras, LIDAR sensors, and AI processing capabilities for accurate infrastructure assessment, defect identification, and maintenance planning. The UAVs are managed by a network of 2 to 4 base stations spaced 10 to 20 km apart, ensuring continuous operation and data collection to support effective infrastructure inspection and monitoring.

Upon receiving the request, the system autonomously generates flight missions and sends them to the base stations. The base stations program the respective UAVs and initiate the launch process. The UAVs take off, reach their working altitude, and proceed to their designated mission areas to begin data collection. Throughout the mission, UAVs with high-resolution cameras and LIDAR sensors capture images and 3D models of infrastructure assets, identify potential defects, and assess the overall structural health. AI processes the collected data and provides valuable insights to the user, enabling informed decision-making and targeted maintenance efforts. The mission operates with continuous 24/7 monitoring, allowing infrastructure managers, engineers, and maintenance teams to make timely interventions, assess asset health, and ensure the safety and longevity of critical infrastructure.

### Mission 9: Wildlife Conservation and Monitoring.

The user requests a mission to monitor and protect wildlife populations and their habitats in a designated area ranging from 500 to 5,000 hectares. The advanced UAV system assesses the feasibility of the task and, upon confirmation, selects suitable base stations and aircraft to meet the mission requirements (see table below). The UAV fleet, consisting of 2 to 5 aircraft, is equipped with high-resolution cameras, thermal cameras, and AI processing capabilities for accurate wildlife tracking, population assessments, and habitat monitoring. The UAVs are managed by a network of 1 to 3 base stations spaced 5 to 15 km apart, ensuring continuous operation and data collection to support effective wildlife conservation and monitoring efforts.

Upon receiving the request, the system autonomously generates flight missions and sends them to the base stations. The base stations program the respective UAVs and initiate the launch process. The UAVs take off, reach their working altitude, and proceed to their designated mission areas to begin data collection. Throughout the mission, UAVs with high-resolution and thermal cameras capture images and videos of wildlife populations, track animal movements, and monitor habitat conditions. AI processes the collected data and provides valuable insights to the user, enabling informed decision-making and targeted conservation efforts. The mission operates with continuous 24/7 monitoring, allowing wildlife managers, conservationists, and researchers to make timely interventions, assess ecosystem health, and ensure the protection of vulnerable wildlife populations and their habitats.

### Mission 10: Coastal Surveillance and Environmental Monitoring.

The user requests a mission to conduct surveillance and environmental monitoring along a stretch of coastline, with a designated area ranging from 2,000 to 20,000 hectares. The advanced UAV system assesses the feasibility of the task and, upon confirmation, selects suitable base stations and aircraft to meet the mission requirements (see table below). The UAV fleet, consisting of 4 to 8 aircraft, is equipped with high-resolution cameras, multispectral cameras, LIDAR sensors, and AI processing capabilities for accurate coastline assessment, environmental monitoring, and maritime surveillance. The UAVs are managed by a network of 3 to 5 base stations spaced 15 to 25 km apart, ensuring continuous operation and data collection to support effective coastal surveillance and environmental monitoring efforts.

Upon receiving the request, the system autonomously generates flight missions and sends them to the base stations. The base stations program the respective UAVs and initiate the launch process. The UAVs take off, reach their working altitude, and proceed to their designated mission areas to begin data collection. Throughout the mission, UAVs with high-resolution cameras, multispectral cameras, and LIDAR sensors capture images and videos of the coastline, track maritime activities, and monitor environmental parameters such as water quality, erosion, and vegetation health.

AI processes the collected data and provides valuable insights to the user, enabling informed decision-making and targeted coastal management efforts. The mission operates with continuous 24/7 monitoring, allowing coastal managers, environmentalists, and maritime authorities to make timely interventions, assess coastal health, and ensure the protection of the coastal environment and its resources.

The following is a summary table of the preferred embodiments discussed above for the 10 missions comprising a 24 hour/7 days continuous operation:

| | | | | | | | Min | Max | Min # of | Max # of | | |
|---|---|---|---|---|---|---|---|---|---|---|---|---|
| | | | | | | | Flight | Flight | Base | Base | Min Dist. | Max Dist. |
| Mission | Mission | | Min | Max | Min # of | Max # of | Time | Time | Stations | Stations | between | between |
| No. | Name | Payloads | Area (ha) | Area (ha) | UAVs | UAVs | (min) | (min) | (BS) | (BS) | BSs (km) | BSs (km) |
| 1 | Huge | Orthophoto | 10,000 | 15,000 | 10 | 20 | 480 | 720 | 2 | 4 | 10 | 25 |
| | Territory + | camera, | | | | | | | | | | |
| | Multitasking | multispectral | | | | | | | | | | |
| | | camera, video | | | | | | | | | | |
| | | camera, | | | | | | | | | | |
| | | atmosphere | | | | | | | | | | |
| | | sensors, AI | | | | | | | | | | |
| | | processing | | | | | | | | | | |
| 2 | Long | Video camera, | 500 | 750 | 3 | 6 | 100 | 150 | 1 | 2 | N/A | 5 |
| | Mission + | AI processing | | | | | | | | | | |
| | One Task + | | | | | | | | | | | |
| | Stable | | | | | | | | | | | |
| | Schedule | | | | | | | | | | | |
| 3 | Coordinated | Video camera, | 1,000 | 10,000 | 5 | 15 | 180 | 720 | 1 | 4 | 5 | 20 |
| | Emergency | thermal camera, | | | | | | | | | | |
| | Response | LIDAR, AI | | | | | | | | | | |
| | | processing | | | | | | | | | | |
| 4 | Precision | Multispectral | 200 | 5,000 | 3 | 10 | 120 | 480 | 1 | 3 | 5 | 15 |
| | Agriculture | camera, LiDAR, | | | | | | | | | | |
| | | hyperspectral | | | | | | | | | | |
| | | camera, AI | | | | | | | | | | |
| | | processing | | | | | | | | | | |
| 5 | Infrastructure | Video camera, | 100 | 2,000 | 2 | 8 | 60 | 240 | 1 | 2 | 2 | 10 |
| | Inspection and | thermal camera, | | | | | | | | | | |
| | Monitoring | LIDAR, AI | | | | | | | | | | |
| | | processing | | | | | | | | | | |
| 6 | Wildlife | Multispectral | 1,000 | 10,000 | 3 | 10 | 180 | 480 | 1 | 3 | 5 | 20 |
| | Conservation | camera, LiDAR, | | | | | | | | | | |
| | and | thermal camera, | | | | | | | | | | |
| | Monitoring | AI processing | | | | | | | | | | |
| 7 | Coastal and | Multispectral | 500 | 5,000 | 3 | 10 | 180 | 360 | 1 | 3 | 5 | 20 |
| | Marine | camera, LiDAR, | | | | | | | | | | |
| | Monitoring | bathymetric | | | | | | | | | | |
| | | LiDAR, AI | | | | | | | | | | |
| | | processing | | | | | | | | | | |
| 8 | Atmospheric | Atmospheric | 1,000 | 10,000 | 3 | 10 | 240 | 720 | 1 | 4 | 5 | 25 |
| | Research and | sensors, | | | | | | | | | | |
| | Monitoring | meteorological | | | | | | | | | | |
| | | sensors, AI | | | | | | | | | | |
| | | processing | | | | | | | | | | |
| 9 | Urban | Video camera, | 100 | 1,000 | 2 | 6 | 60 | 180 | 1 | 2 | 2 | 10 |
| | Planning and | LiDAR, | | | | | | | | | | |
| | Development | multispectral | | | | | | | | | | |
| | | camera, AI | | | | | | | | | | |
| | | processing | | | | | | | | | | |
| 10 | Integrated | Video camera, | 50 | 500 | 2 | 6 | 60 | 240 | 1 | 2 | 1 | 5 |
| | Security and | thermal camera, | | | | | | | | | | |
| | Surveillance | AI processing | | | | | | | | | | |

The advanced UAV system described herein is designed to support a wide range of missions and operational requirements, enabling continuous 24/7 operation with a plurality of UAVs assigned to a plurality of base stations across diverse geographic locations worldwide. This versatile system can adapt to various mission requirements and environmental conditions, showcasing its global applicability.

It should be emphasized that the above-described embodiments are merely possible examples of implementations. Many variations and modifications may be made to the above-described embodiments. All such modifications and variations are intended to be included herein within the scope of the disclosure and protected by the following claims. The invention has been described in detail with particular reference to certain preferred embodiments thereof, but it will be understood that variations and modifications can be effected within the spirit and scope of the invention.

We claim:

1. An unmanned aerial vehicle (UAV) deployment system comprising:
a plurality of UAV base stations, each having a movable UAV housing container;
a plurality of UAVs equipped to carry assorted payloads;
a system control center comprising a UAV management system; and
a computer station having a user application and interface, and
wherein each UAV base station can simultaneously store and charge multiple UAVs.

2. The system of claim 1, wherein each UAV is interconnected to both plurality of other UAVs and to multiple UAV base stations, facilitating data exchange.

3. The system of claim 1, wherein the UAV base stations are configured to interact with the system control center for mission assignments and UAV data exchange, and the system control center communicates with the computer station to transmit data streams and accept mission requests from the computer station.

4. An UAV base station comprising:
a housing container;
an operable roof;
a landing/takeoff platform;
cassette covers comprising a manipulator with sensory capabilities for UAV, a plurality of lifts or elevators, cameras and sensors;
data management modules, wherein data connectivity is enabled through universal serial bus (USB) interfaces;
battery management module having a charge control unit and a charging nest;
dedicated power and control units;
a manipulator MCU; and,
a tower MCU for controlling the plurality of lifts or elevators.

5. The UAV base station of claim 4, wherein cassette covers are configured to move UAVs for storage, recharging or takeoff, facilitated by integrated lifts or elevators.

6. The UAV base station of claim 4, wherein the manipulator's MCU manages movements for UAV reception and arrangement, using sensors to pinpoint UAV landing locations.

7. The UAV base station of claim 4, wherein the tower MCU further controls charging of UAVs, cassette cover movement, and roof operations.

8. The UAV base station of claim 4, wherein each of the plurality of UAV base stations is configured to command and control its housing container and can transmit instructions to the plurality of UAVs housed inside its immediate housing container and transmit to or receive instructions from other networked UAV base stations and UAVs.

9. The UAV base station of claim 4, wherein the housing container is configured to facilitate payload management for a plurality of UAVs.

10. An interconnected UAV comprising:
a rechargeable battery and battery management module;
a tri-sectional fuselage;
at least two pairs of wing-affixed folding propellers for vertical thrust;
a rear propeller for both vertical and horizontal propulsion; and
wherein the UAV is interconnected with a UAV base station and a UAV housing container where the UAV is stored and recharged.

11. The interconnected UAV of claim 10, wherein the at least two pairs of wing-fixed folding propellers are positioned such that two of the propellers are affixed to the top and two propellers affixed to the bottom of each wing and each of the propellers extend above and below each wing perpendicular relative to both the length of the fuselage and the length of the wing.

12. The interconnected UAV of claim 10, wherein each UAV further comprises:
a charging assembly affixed to the top of one of the vertical stabilizers on the UAV configured to nest inside a charging receptor affixed to steel plate inside the housing container;
wherein the charging assembly of the UAV is configured to transmit and facilitate data exchange and electrical transfer between it and the charging receptor in the housing container.

13. The interconnected UAV of claim 10, wherein the UAV is configured such that all of the propellers work together to optimize in-flight adjustability enabling efficient vertical takeoff and horizontal propulsion.

14. A UAV battery management method comprising:
monitoring UAV battery levels;
identifying proximal UAV base stations;
redirecting UAVs for recharging; and,
commissioning alternate UAVs for mission continuity.

15. An integrated UAV management architecture including:
a computer station comprising a user application;
a system control center;
a plurality of UAV base stations;
wherein each of the plurality of UAVs are assigned to respective base stations, and each of the plurality of the UAVs can be reassigned to other base stations to carry out missions.

16. The management system of claim 15, wherein the control center effectively regulates multiple UAV base stations and UAVs, dispatching missions and aggregating data.

17. The management system of claim 15, enabling the strategic relocation of UAVs across different base stations as required.

18. A UAV mission optimization method comprising:
identifying a plurality of UAV base stations networked together via a system control center; wherein, each of the UAV base stations houses a plurality of UAVs;
analyzing each of the UAV base station's operational health;
assessing each of the UAV's flight and battery statuses within each base station;
processing and prioritizing multiple UAV mission requests,
commencing agile deployment of UAVs based on priorities; and,
providing continuous mission and UAV-base station link updates.

19. The method of claim 18, further comprising expanding or contracting the UAV base station network to optimize UAV operability and expedite mission completion, while leveraging airspace data for enhanced mission success predictions.

20. The method of claim 18, wherein in the event of UAV or base station failures, contingency UAV deployments are activated to ensure uninterrupted operations.
